(19) United States
(12) Patent Application Publication
(10) Pub. No.: US 2013/0165619 A1
(43) Pub. Date: Jun. 27, 2013

(54) LIGHT-FAST POLYURETHANES AND USE THEREOF

(71) Applicants: Birgit Meyer Zu Berstenhorst, Leverkusen (DE); Uwe Pfeuffer, Leverkusen (DE); Norbert Eisen, Koln (DE)

(72) Inventors: Birgit Meyer Zu Berstenhorst, Leverkusen (DE); Uwe Pfeuffer, Leverkusen (DE); Norbert Eisen, Koln (DE)

(73) Assignee: Bayer Intellectual Property GmbH, Monheim (DE)

(21) Appl. No.: 13/816,290

(22) PCT Filed: Aug. 9, 2011
(86) PCT No.: PCT/EP2011/063717

§ 371 Date: Mar. 6, 2013

(30) Foreign Application Priority Data
Aug. 12, 2010 (DE) 10 2010 039 241.3

(51) Int. Cl. C08G 18/06

(52) U.S. Cl. CPC C08G 18/06
USPC 528/49; 428/423.1

(57) ABSTRACT

The invention relates to light-fast polyurethanes and to the use thereof.

The present invention relates to lightfast polyurethanes and to the use thereof.

Polyurethanes (PUR) based on isocyanates with aromatic NCO groups are known to have a tendency to discoloration under the action of light. This is a problem in exterior applications or in interior parts under the action of light. For production of light-resistant mouldings, therefore, aliphatic starting materials and, in the case of isocyanates, those compounds in which the NCO groups are not bonded directly to an aromatic group are selected. In WO 2004/000905, such aliphatic isocyanates are used to prepare lightfast polyurethanes. The problem of the high VOC values (Volatile Organic Compounds) is also addressed, there being a requirement for maximum values of 250 ppm, preferably <100 ppm, from the automotive industry for applications in automobile interiors. As a solution, in WO 2004/000905, incorporable catalysts having functional groups (—OH, —NH—, —NH₂) or high molecular weight catalysts are used, since the commercially available, non-incorporable bismuth and tin catalysts having alkyl ligands in which fewer than 13 carbons are present increase the VOC values. The incorporable catalysts which are described in WO 2004/000905 are not commercially available. Preference is given to using combinations of bismuth and tin catalysts, in which case the bismuth catalyst serves as the starter catalyst and the tin catalyst as the curing catalyst.

When bismuth catalysts with alkyl ligands having fewer than 13 carbon atoms are used, the VOC values are markedly increased.

There is still an interest in minimizing the amount of catalyst for reasons of cost and for ecological reasons.

U.S. Pat. No. 4,242,463 discloses that tin(II) octoate (Dabco T-9) in combination with dimethyltin(IV) dilaurate is suitable as a catalyst for color stable integral skin polyurethane foams. It is found, however, that tin(II) octoate is very unstable to hydrolysis, and therefore such systems are not storage-stable since their activity decreases significantly after only a few days.

It was therefore an object of the invention to produce a lightfast polyurethane (PUR) material which has low VOC values, is rapidly demouldable, is storage-stable for a few days and is producible inexpensively. The reactants should be commercially available. In order to save costs, the components must be rapidly demouldable. It is necessary in this context that the reactive starting materials for production of polyurethanes set rapidly and already have a certain hardness when they are demoulded. On the other hand, however, a certain initiation time, which should not be too short, is also required in order to be able to fill the mould completely. For this purpose, at least 20 seconds should be available (initiation time >20 seconds). The setting time should if at all possible not be less than 30 seconds.

It has been found that, surprisingly, the combination of at least one or a plurality of dimethyltin(IV) dimercaptides and at least one or a plurality of dimethyltin(IV) dicarboxylates achieves this object and additionally exhibits a synergistic effect, such that only a very small total amount of catalyst need be used, or a higher activity can be achieved than in the case of sole use of one catalyst component. Furthermore, this combination has barely any propensity to be hydrolysed, if any at all.

The invention provides lightfast polyurethanes obtainable in the presence of e) catalysts and 1) amine initiators by reaction of
a) one or more polyisocyanate components, at least one polyisocyanate component containing at least 2 NCO groups not directly bonded to an aromatic group, with
b) one or more compounds containing at least two groups reactive towards NCO groups
c) optionally chain extenders and/or crosslinkers, in the presence of
d) optionally assistants and/or additives,
   using, as catalysts e), a combination of one or more dimethyltin(IV) dimercaptides and one or more dimethyltin(IV) dicarboxylates.

The catalyst combination is preferably used in an amount of 0.2 to 2 per cent by weight, more preferably 0.4 to 1 per cent by weight, based on the sum of components b), c), d), e) and 0. The molar ratio of dimethyltin(IV) dicarboxylates to dimethyltin(IV) dimercaptides is 99:1 to 1:1, preferably from 99:1 to 3:2, more preferably from 99:1 to 5:4.

The dimethyltin(IV) dimercaptides used are preferably catalysts from the group consisting of dimethyltin(IV) didodecylmercaptide, dimethyltin(IV) bis(2-ethylhexylthioglycolate), dimethyltin(IV) di(methylene isooctyl ester)mercaptide and dimethyltin(IV) didecylmercaptide.

The dimethyltin(IV) dicarboxylates used are preferably catalysts from the group consisting of dimethyltin(IV) butenyldicarboxylate, dimethyltin(IV) dilaurate and dimethyltin(IV) dineodecylcarboxylate.

The inventive polyurethanes have initiation times of ≧20 seconds and setting times of ≧30 seconds.

In the preparation of polyurethanes, the initiation time refers to the time specifying the duration of the mixing of the reaction components until reaction is visually perceptible. The setting time is defined as that time which is required from the mixing of the reaction components until the surface has solidified. In order to be able to fill a mould completely, the setting time should not be too small.

As well as the surface hardness, however, the curing of the material in the core is also important in order to be able to demould in a problem-free manner, since the component can otherwise warp.

The curing of the material is determined by penetration measurement. This involves determining the penetration depth using a penetrator (for example the H-4236 cone penetrometer from Humboldt) with load 1400 g and a rounded penetration tip having a diameter of 2.5 mm, 60 seconds after mixing at room temperature. Small values represent good curing, large values poor conversion/curing.

An inventive, rapidly demouldable polyurethane should a) have a certain surface hardness, which is described by the setting time, and b) have a certain curing after 1 minute, which is defined by the penetration measurement.

For good mould filling and rapid demouldability, the setting time should be between 30 and 50 seconds. Preferred penetration depths are values between 1.8 and 10 mm, and values less than 3.5 mm are helpful for very good demouldability.

The inventive polyurethane preferably has a density of greater than 350 g/cm³.

The polyisocyanate components a) used are organic isocyanate compounds having at least two isocyanate groups not bonded directly to an aromatic group.

The invention further provides a process for preparing the inventive lightfast polyurethanes, which is characterized in that
a) one or more polyisocyanate components, at least one polyisocyanate component containing at least two NCO groups not directly bonded to an aromatic group, are reacted with
b) one or more compounds containing at least two groups reactive towards NCO groups,
c) optionally chain extenders and/or crosslinkers,
in the presence of
d) optionally assistants and/or additives,
e) catalysts and
f) amine initiators, using, as catalysts e), a combination of one or more dimethyltin(IV) dimercaptides and one or more dimethyltin(IV) dicarboxylates.

The polyol components b) used are preferably polyether polyols and/or polyester polyols and/or aliphatic oligocarbonate polyols having terminal OH groups, an average nominal functionality of 2 to 8 and an average equivalent weight of 100 to 4000, preferably 300 to 4000.

The components c) used are preferably 1 to 30% by weight, based on the weight of components b), c), d), e) and f), of at least one compound having, as functional groups, only aliphatic or alicyclic OH groups, a functionality of 2 to 8, a molecular weight of 62 to 500 g/mol and a content of primary OH groups of at least 50%.

The components f) used are preferably 1 to 10% by weight, based on the weight of components b), c), d), e) and f), of at least one amine initiator component which forms a co-catalytic system with the catalyst component e) and has 2 to 6 functional aliphatic NH, NH₂ or OH groups, at least one of which is a secondary or primary amino group, and has an equivalent weight of up to a maximum of 200.

The component e) used is a mixture of at least two dimethyltin(IV) catalysts, one catalyst preferably being at least
one dimethyltin(IV) dimercaptide of the formula III
and the second catalyst at least
one dimethyltin(IV) dicarboxylate of the formula I or II.

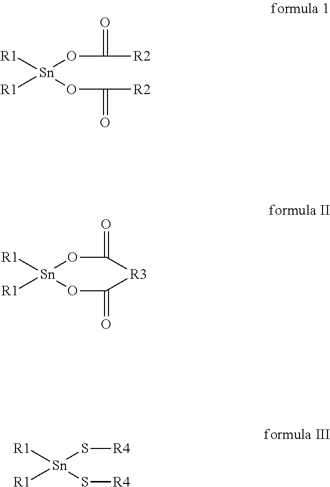

where R1=CH₃;
R2=linear or branched alkyl or alkenyl group having 1 to 19, preferably 1 to 13, more preferably 4 to 11 carbon atoms;
R3=linear or branched alkylene or alkenylene group having 1 to 19, preferably 1 to 13, more preferably 1 to 5 carbon atoms;
R4=linear or branched alkyl or alkenyl group having 1 to 19 carbon atoms, optionally containing heteroatoms, for example O, S, N, preferably having 2 to 14, more preferably having 4 to 14 carbon atoms.

Particular preference is given to using a dimethyltin(IV) dicarboxylate of the formula I and a dimethyltin(IV) dimercaptide of the formula

The polyisocyanate components a) used are (cyclo)aliphatic polyisocyanates, preferably diisocyanates. Suitable diisocyanates are any diisocyanates which are obtainable by phosgenation or by phosgene-free processes, for example by thermal urethane cleavage, are of the molecular weight range of 140 to 400 and have aliphatically or cycloaliphatically bonded isocyanate groups, for example 1,4-diisocyanatobutane, 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3)isocyanato-methylcyclohexane, bis(isocyanatomethyl)norbornane or any desired mixtures of such diisocyanates. For preparation of the inventive polyurethanes, isophorone diisocyanate (IPDI) and hexamethylene diisocyanate (HDI) are particularly suitable. The isocyanates can be used in the form of the pure compound or in modified form, for example in the form of uretdiones, isocyanurates, allophanates, biurets, with iminooxadiazinedione and/or oxadiazinetrione structure or in the form of reaction products containing urethane and isocyanate groups, called isocyanate prepolymers, and/or carbodiimide-modified isocyanates. The isocyanates a) preferably have an isocyanate content of 15 to 35% by weight. Preferred but non-exclusive isocyanate components are low-viscosity products based on IPDI with a monomer content of 45 to 95% by weight, preferably 55-90% by weight.

Component b) preferably has a mean hydroxyl functionality of 2 to 8 and preferably consists of at least one polyhydroxy polyether having a mean molecular weight of 1000 to 15 000 g/mol, preferably 2000 to 13 000 g/mol, and/or at least one polyhydroxy polyester having a mean molecular weight of 1000 to 10 000 g/mol, preferably 1200 to 8000 g/mol, and/or of at least one aliphatic oligocarbonate polyol having a mean molecular weight of 200 to 5000 g/mol, preferably 400 to 1000 g/mol.

Suitable polyhydroxy polyethers are the alkoxylation products, known per se from polyurethane chemistry, of preferably di- or trifunctional starter molecules or mixtures of such starter molecules. Suitable starter molecules are, for example, water, ethylene glycol, diethylene glycol, propylene glycol, trimethylolpropane, glycerol and sorbitol. Alkylene oxides used for alkoxylation are especially propylene oxide and ethylene oxide, these alkylene oxides being usable in any sequence and/or as a mixture.

Suitable polyester polyols are the esterification products, which have hydroxyl groups and are known per se, of preferably di- or trihydric alcohols, for example ethylene glycol, propylene glycol, neopentyl glycol, 1,4-butanediol, 1,6-hexanediol and trimethylolpropane, with substoichiometric amounts of preferably difunctional carboxylic acids, for example succinic acid, adipic acid, phthalic acid, tetrahydrophthalic acid, hexahydrophthalic acid or mixtures of such acids.

Suitable aliphatic oligocarbonate polyols are the transesterification products, known per se, of monomeric dialkyl carbonates, for example dimethyl carbonate, diethyl carbonate etc., with polyols or mixtures of polyols having an OH functionality of ≧2.0, for example 1,4-butanediol, 1,3-butanediol, 1,5-pentanediol, 1,6-hexanediol, 3-methyl-1,5-pentanediol, 1,12-dodecanediol, cyclohexanedimethynol, trimethylolpropane and/or mixtures of the polyols mentioned with lactones, as described, for example, in EP-A 1 404 740 and EP-A 1 518 879 A2.

Component c) preferably comprises difunctional chain extenders having a molecular weight of 62 to 500 g/mol, preferably 62 to 400 g/mol. The preferred chain extenders c) include dihydric alcohols, for example ethylene glycol, diethylene glycol, 1,4-butanediol, 1,6-hexanediol or mixtures of such diols. Likewise suitable as component c), or as part of component c), are diols having ether groups and having molecular weights below 400 g/mol, as obtainable by propoxylation and/or ethoxylation of difunctional starter molecules of the type already specified above by way of example. Any desired mixtures of the chain extenders mentioned by way of example may likewise be used. The chain extenders c) are preferably used in amounts of 1 to 30% and preferably 2 to 15% by weight, based on the weight of components b), c), d), e) and f).

Component f) is an amine initiator component which forms a co-catalytic system with the catalyst component e) and has preferably 2 to 6 functional —NH, NH₂ or OH groups not bonded directly to an aromatic group, of which at least one group is a secondary or primary amino group, and has an equivalent weight of up to a maximum of 200. Suitable amine initiators are described, for example, in EP 0929586 B1; in addition, it is also possible to use Jeffamines. The preferred amine initiators include diethanolamine, triethanolamine, ethanolamine, m-xylylenediamine, dimethylethanolamine and IPDA (isophoronediamine).

Component e) is a mixture of at least two dimethyltin(IV) catalysts, preference being given to the presence of at least one dimethyltin(IV) dimercaptide of the formula III and at least one dimethyltin(IV) dicarboxylate of the formula I or II.

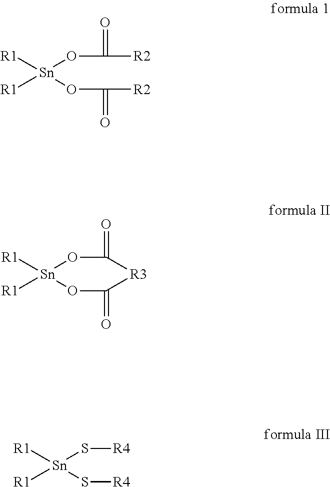

where R1=CH₃;
R2=linear or branched alkyl or alkenyl group having 1 to 19, preferably 1 to 13, more preferably 4 to 11 carbon atoms;
R3=linear or branched alkylene or alkenylene group having 1 to 19, preferably 1 to 13, more preferably 1 to 5 carbon atoms;
R4=linear or branched alkyl or alkenyl group having 1 to 19 carbon atoms, optionally containing heteroatoms, for example O, S, N, preferably having 2 to 14, more preferably having 4 to 14 carbon atoms.

Particular preference is given to a mixture of dimethyltin(IV) dineodecylcarboxylate and dimethyltin(IV) didodecylmercaptide, the molar mixing ratio of dimethyltin(IV) di(neodecylcarboxylate) to dimethyltin(IV) didodecylmercaptide being in the range from 99:1 to 1:1, preferably from 99:1 to 3:2, more preferably from 99:1 to 5:4. At these preferred mixing ratios, a particularly small amount of component e) is required, or a higher activity is attained than in the case of the sole use of one of the catalyst components in the same molar amount.

The assistants and additives d) used may be compounds of the type known per se. In the preparation of polyurethanes, it is additionally possible to use, as assistants and additives d), the customary compounds, for example stabilizers, blowing agents and especially water, which can optionally be used in an amount of up to 0.3% by weight, based on the weight of components b), c), d), e) and f). However, preference is given to conducting the preparation of the polyurethanes without added water.

The starting components are also used in such amounts that an isocyanate index of 80 to 120, preferably 95 to 105, is obtained. The isocyanate index is the ratio of the number of NCO groups to the number of groups which react with the NCO groups, multiplied by 100.

To prepare the polyurethanes, components b) to 0 are combined to give a “polyol component B”, which are then mixed with the polyisocyanate component and reacted, for example, in closed moulds. In this context, customary measurement and metering apparatus is used.

The temperature of the reaction components (polyisocyanate component and polyol component B) is generally within a temperature range from 20 to 60° C. The temperature of the moulds is generally 20 to 100° C.

The amount of material introduced into the mould is such that the resulting densities of the mouldings are from preferably 350 to 1100 kg/m³.

The inventive polyurethanes are used, for example, for coating of suitable substrates, for example metal, glass, wood or plastics. They are particularly suitable for production of steering wheels, door trim and instrument panel covers, and of automotive interior decor elements.

The invention is to be illustrated in detail by the examples which follow.

### EXAMPLES

### Component a):

Aliphatic polyisocyanate (composed of 70% by weight of IPDI and 30% by weight of IPDI isocyanurate) having an NCO content of 30.5% by weight and a viscosity of 200 mPas at 25° C.

### Component b):

Polyether polyol having an OH number of 28; prepared by alkoxylation of sorbitol with propylene oxide/ethylene oxide (PO/EO) in a weight ratio of 82:18 and predominantly primary OH end groups.

Component c): 1,4-Butanediol having an OH number of 1245.

### Component f):

Amine initiator composed of ethanolamine and diethanolamine in a mixing ratio in terms of percentage by weight of 5:4.

### Component e):

E1: Fomrez UL 1 (CAS No. 1185-81-5) from Momentive Performance Materials Inc., Germany; dibutyltin(IV) didodecylmercaptide
E2: Fomrez UL 2 (CAS No. 78-04-6 from Momentive Performance Materials Inc., Germany; dibutyltin(IV) butenyldicarboxylate
E3: Fomrez UL 22 (CAS No. 51287-84-4) from Momentive Performance Materials Inc., Germany; dimethyltin(IV) didodecylmercaptide
E4: Fomrez UL 28 (CAS No. 68928-76-7) from Momentive Performance Materials Inc., Germany; dimethyltin(IV) di(neodecylcarboxylate)
E5: Fomrez UL 29 (CAS No. 26401-97-8) from Momentive Performance Materials Inc., Germany; dioctyltin(IV) di(methylene isooctyl ester)mercaptide
F6: Fomrez UL 32 (CAS No. 22205-30-7) from Momentive Performance Materials Inc., Germany; dioctyltin(IV) didecylmercaptide
E7: Dabco T9 (CAS No. 301-10-0) from Air Products, Germany; tin(II) dioctylcarboxylate

### Formulation:

Isocyanate component a): The amounts are each specified in the tables. The isocyanate index in each case is 100.
Component b): 88 g
Component c): 7.4 g
Component f): 4.5 g
Component e) is specified as the molar amount in mmol. A standard total molar amount of 1.5 mmol is used. In the case of mixtures, the respective proportions are specified in the tables.

Components b), c), e) and f) are weighed in order into a beaker and mixed. Subsequently, the isocyanate component a) is added and the overall system is stirred with a Pendraulic stirrer at approx. 2500 rpm at room temperature for approx. 10 sec.

### Example 1

### Use of a Single Catalyst

The catalysts are used individually in an amount of 1.5 mmol.

| | | Example | | | | | | |
|---|---|---|---|---|---|---|---|---|
| | | 1a | 1b | 1c | 1d | 1e | 1f | 1g |
| Catalyst | | E1 | E2 | E3 | E4 | E5 | E6 | E7 |
| Isocyanate | [g] | 47.0 | 47.2 | 47.1 | 47.1 | 46.9 | 46.9 | 47.2 |
| Initiation time | [sec] | 68 | 39 | >60 | 23 | >60 | >60 | 47 |
| Setting time | [sec] | n.d. | 60 | n.d. | 35 | n.d. | n.d. | 80 |
| Penetration | [mm] | n.d. | 9.2 | n.d. | 3.5 | n.d. | n.d. | 30 |
| 1400 g/60 sec | | | | | | | | |

It can be seen that a single catalyst is too inactive to fulfill the demands for setting times of less than 50 seconds and penetrations of less than 3.5 mm.

### Example 2

### Combination of Two Different Tin(IV) Catalysts

| Example | | 2a | 2b | 2c |
|---|---|---|---|---|
| Isocyanate | [g] | 47.1 | 47.1 | 47.1 |
| Catalyst E4 and E1 | | | | |
| Molar amount of E4 | [mmol] | 1.35 | 1.05 | 0.75 |
| Molar amount of E1 | [mmol] | 0.15 | 0.45 | 0.75 |
| Initiation time | [sec] | 29 | 32 | 40 |
| Setting time | [sec] | 36 | 43 | 55 |
| Penetration | [mm] | 5.4 | 5.3 | 8.5 |
| 1400 g/60 sec | | | | |

| Example | | 2d | 2e | 2f |
|---|---|---|---|---|
| Isocyanate | [g] | 47.2 | 47.2 | 47.2 |
| Catalyst E4 and E2 | | | | |
| Molar amount of E4 | [mmol] | 1.2 | 0.75 | 0.3 |
| Molar amount of E2 | [mmol] | 0.3 | 0.75 | 1.2 |
| Initiation time | [sec] | 30 | 40 | 48 |
| Setting time | [sec] | 45 | 55 | 90 |
| Penetration | [mm] | 6.1 | 10.7 | 30.0 |
| 1400 g/60 sec | | | | |

| Example | | 2g* | 2h* | 2i | 2j |
|---|---|---|---|---|---|
| Isocyanate | [g] | 47.1 | 46.4 | 47.0 | 45.8 |
| Catalyst E4 and E3 | | | | | |
| Molar amount of E4 | [mmol] | 1.35 | 0.9 | 0.6 | 0.45 |
| Molar amount of E3 | [mmol] | 0.15 | 0.6 | 0.9 | 1.05 |
| Initiation time | [sec] | 23 | 26 | 31 | 37 |
| Setting time | [sec] | 30 | 35 | 43 | 50 |
| Penetration | [mm] | 3.3 | 3.4 | 3.9 | 5.2 |
| 1400 g/60 sec | | | | | |
| VOC value (to | [mg/kg] | 29 | 63 | — | — |
| VDA 278) | | | | | |

*inventive

| Example | | 2k | 2l | 2m |
|---|---|---|---|---|
| Isocyanate | [g] | 47.1 | 47.1 | 47.0 |
| Catalyst E4 and E5 | | | | |
| Molar amount of E4 | [mmol] | 1.35 | 0.9 | 0.6 |
| Molar amount of E5 | [mmol] | 0.15 | 0.6 | 0.9 |
| Initiation time | [sec] | 27 | 34 | 43 |
| Setting time | [sec] | 36 | 47 | 66 |
| Penetration | [mm] | 5.9 | 6.8 | 11.8 |
| 1400 g/60 sec | | | | |

| Example | | 2n | 2o | 2p |
|---|---|---|---|---|
| Isocyanate | [g] | 47.1 | 47.1 | 47.0 |
| Catalyst E4 and E6 | | | | |
| Molar amount of E4 | [mmol] | 1.35 | 1.05 | 0.75 |
| Molar amount of E6 | [mmol] | 0.15 | 0.45 | 0.75 |
| Initiation time | [sec] | 26 | 30 | 35 |
| Setting time | [sec] | 31 | 38 | 50 |
| Penetration | [mm] | 4.0 | 4.0 | 5.3 |
| 1400 g/60 sec | | | | |

The best combination is the inventive catalyst combination of E4 and E3, since both the setting times are below 50 seconds and the penetration values are below 3.5 mm. Compared to the sole use of catalyst E4, it is thus possible through combination with catalyst E3 to achieve a higher activity with the same total molar amount of catalyst. In addition, it is apparently also possible to attain low VOC values less than 100 ppm [mg/kg] with non-incorporable catalysts.

### Example 3

### Comparison of Tin(II) Catalyst and Tin(IV) Mercaptide

In order to test the storage stability of tin(II) and tin(IV) catalysts, a mixture of a tin(II) catalyst (E7) {Ex. 3a-c} or of a tin(IV) dimercaptide (E3) {Ex. 3d-f} (0.9 mmol) with dimethyltin(IV) di-(neodecylcarboxylate) (E4; 0.6 mmol) was used in each case. The polyol systems comprising the aforementioned catalyst mixtures were used directly (0 value) and after 4 or 17 days of storage in order to assess the activity of the catalyst mixtures.

| | | Example | | | | | |
|---|---|---|---|---|---|---|---|
| | | 3a | 3b | 3c | 3d* | 3e* | 3f* |
| Catalyst | | E4 and E7 | | | E4 and E3 | | |
| Storage | | 0 | 4 days | 17 days | 0 | 4 days | 17 days |
| of the | | value | | | value | | |
| polyol | | | | | | | |
| system | | | | | | | |
| comprising | | | | | | | |
| the | | | | | | | |
| catalyst | | | | | | | |
| mixture | | | | | | | |
| Initiation | [sec] | 23 | 50 | 70 | 26 | 36 | 32 |
| time | | | | | | | |
| Setting | [sec] | 28 | 75 | 110 | 35 | 48 | 40 |
| time | | | | | | | |
| Penetration | [mm] | 2.3 | 17.0 | 30.0 | 3.4 | 3.9 | 4.8 |
| 1400 g/ | | | | | | | |
| 60 sec | | | | | | | |

*inventive

It can be seen that the mixture of tin(II) catalyst with dimethyltin(IV) di(neodecylcarboxylate) (examples 3a to 3c) is at first very active, and the setting time is even sometimes somewhat too short, but barely reacts any more after 4 days (penetration >15 mm). In contrast, the inventive system comprising a dimethyltin(IV) dimercaptide and dimethyltin(IV) di(neodecylcarboxylate) (Examples 3d-3f) likewise exhibits good initial activity (penetration <3.5 mm and good setting time within a manageable range), but this barely declines. Thus, it is inadvisable to use tin(II) catalysts in polyol compositions which need to have a certain degree of storage stability.

1-6. (canceled)

7. A lightfast polyurethane obtained in the presence of a catalyst e) and an amine initiator f) by reacting
a) one or more polyisocyanate component, at least one polyisocyanate component containing at least two NCO groups not directly bonded to an aromatic group, with
b) one or more compound containing at least two groups reactive towards NCO groups, and
c) optionally chain extenders and/or crosslinkers,
in the presence of
d) optionally assistants and/or additives,
wherein the catalyst e) is a combination of one or more dimethyltin(IV) dimercaptide and one or more dimethyltin(IV) dicarboxylate.

8. A substrate coated with the lightfast polyurethane according to claim 7.

9. The substrate according to claim 8, wherein the substrate is a coated polymer moulding.

10. The substrate according to claim 8, wherein the substrate is a steering wheel, a door trim, an instrument panel cover or an automotive interior decor element.

11. A process for preparing the lightfast polyurethane according to claim 7, comprising
a) reacting one or more polyisocyanate component, at least one polyisocyanate component containing at least two NCO groups not directly bonded to an aromatic group, with
b) one or more compound containing at least two groups reactive towards NCO groups, and
c) optionally chain extenders and/or crosslinkers,
in the presence of
d) optionally assistants and/or additives,
e) a catalyst and
f) an amine initiator,
wherein the catalyst e) is a combination of one or more dimethyltin(IV) dimercaptide and one or more dimethyltin(IV) dicarboxylate.

12. A process of producing a steering wheel, a door trim, an instrument panel cover or an automotive interior decor element comprising utilizing the lightfast polyurethane according to claim 7.
